(19) United States
(12) Patent Application Publication
(10) Pub. No.: US 2013/0119575 A1
(43) Pub. Date: May 16, 2013

(54) Plastic Waste Recycling Apparatus and System

(71) Applicant: NEXTLIFE ENTERPRISES, LLC, Boca Raton, FL (US)

(72) Inventors: Ronald Lee Whaley, Boca Raton, FL (US); Anilkumar Rasiklal Shah, Boca Raton, FL (US); Huimin Zhao, Zhangjiagang City (CN)

(73) Assignee: NEXTLIFE ENTERPRISES, LLC, Boca Raton, FL (US)

(21) Appl. No.: 13/623,518

(22) Filed: Sep. 20, 2012

Related U.S. Application Data
(63) Continuation-in-part of application No. 13/294,893, filed on Nov. 11, 2011.

(51) Int. Cl. B02C 18/22; B29C 47/10; B02C 23/40

(52) U.S. Cl. 264/140; 241/42; 241/98

(57) ABSTRACT

A process and apparatus for recycling plastic waste material, including shredding the waste material in a universal shredder apparatus and washing the waste material. The apparatus and method includes a dryer apparatus for drying substantially all moisture from the plastic, and an agglomeration process that is performed in an agglomeration apparatus which receives the dry film material from the dryer and creates a course mix of chopped material. Multiple in-line extruders process the cleaned plastic with filter screens positioned after each extruder to mix and filter the plastic into a final uniform mixed product harvested by a pelletizer.

### CROSS-REFERENCE TO RELATED APPLICATIONS

This application is a Continuation-In-Part application of co-pending U.S. application Ser. No. 13/294,893 (filed Nov. 11, 2011), which application is entirely incorporated herein by reference and made a part hereof.

### STATEMENT REGARDING FEDERALLY-SPONSORED RESEARCH OR DEVELOPMENT

Not applicable.

### TECHNICAL FIELD

The present invention relates to an assembly and system for recycling plastic waste material. More specifically, the present invention relates to an apparatus and method for recycling plastic film and/or rigid plastic material that includes washing and purifying the recycled plastic, as well as processing the plastic material into a purified course ground mixture, to administer into an extruder apparatus to create extruded plastic pellets that may be used to manufacture plastic products, including consumer packaging products.

### BACKGROUND

Popular use of plastic to manufacture consumer and industrial products results in a substantial amount of plastic waste being available for recycling into material for again manufacturing such products, but very little is recycled an used in this manner. Despite public interest in reclaiming materials form waste and the rise in plastic waste collection efforts, most plastic waste is buried in landfills and is never recycled. A main reason plastic recycling is not more widely practiced is that conventional recycling processes commercially viable for large volume of material do not yield plastic free of contaminants such that the plastic has the purity for universal use in manufacturing processes. For example, conventionally processed recycled plastic is not suitable for certain manufacturing processes such as the process for making plastic film products. Similarly, conventional recycled plastic is not suitable for use in manufacturing food packaging for which strict compliance with specific criteria must be met, including U.S. Food and Drug Administration guidelines and approval criteria. It is desirable for recycled plastic material to meet such guidelines and to be suitable to manufacture a variety of products without restriction. As a result of such limited applicability of conventional recycled material, there is generally less demand for the material.

Accordingly, it is desirable to avoid contaminants in recycled plastic material, such as cellulose (paper fiber) and adhesives (residual of glue). It is also desirable to avoid blends of different types of plastic polymers, such as contaminants of polystyrene in recycled polypropylene material. These types of contaminants are typical in plastic material generated from conventional recycling equipment and processes available today.

There have been attempts to address issues of the purity of recycled plastic material. For example, the U.S. Pat. No. 5,667,151 issued to Miura et al. discloses a process for collection of plastic waste that includes the steps of crushing the waste plastic and subjecting the crushed material to a heat and passing the material through a trough with a specific piping with a spiral shape. U.S. Pat. No. 6,588,597, issued to Arakane et al., discloses a system for treating plastic material that includes dry cleaning of the material, which includes crushing the plastic into small pieces and applying a mechanical impact force on the particles in an effort to clean the plastic of debris without the use of a wash liquid. Additionally, U.S. Patent No. 5,143,308, issued to Halley et al. discloses a recycling system in which plastic material is separated by the type of plastic, and the material is ground and converted into flakes for processing to remove contaminants from the surface of the flakes. Finally, U.S. Pat. No. 5,894,996, issued to Williams, discloses a method for reclaiming plastic which includes the steps of fragmenting the plastic and “sizing” the fragments to remove certain size fragments prior to continuing with additional steps to loosen contamination from the selected fragments in a specifically structured vessel.

These methods and assemblies, however, have not resolved the need for a reliable and commercially feasible process and assembly that recycles plastic material into a versatile highly purified state. Thus, there remains a need for a plastic recycling system that is both economical and reliable for producing high volume of recycled plastic material that has the purity for use in manufacturing a variety of products, including food packaging products and the desire for such plastic material to meet FDA approval for food-contact packaging. Further, there is a need for a process that includes multi-stage washing mechanisms for removing non-plastic contaminants from the material being recycled, while maintaining the ability for the material to be transported via a screw-type conveyer system to the extruder apparatus. This may include the interim step of accumulating and/or storing the material in a hopper prior to the extrusion process. This solves the potential problem of clumping and packing of the material prior to the extrusion process, such as may occur with plastic film material that has been thoroughly washed and has the tendency to tightly pack and/or clump due to stickiness. Thus, there is a need for a method and apparatus that further processes the plastic material to maintain the movability and flowable state of the material. These and other objectives are met with the invention disclosed herein, providing solutions heretofore unavailable.

### BRIEF SUMMARY

It is an object of the present invention to provide an assembly for recycling plastic waste material that has an intake for introducing the waste material into a universal shredder having a shredder blade and an output for directing shredded plastic waste material toward a shredder conveyor apparatus that is configured to convey the shredded material toward a rigid plastic recycling line or to a plastic film recycling line. The rigid plastic recycling line has a rigid material grinding assembly and a water bath assembly for separating the rigid plastic material by density, and the rigid line also has at least one dryer apparatus for drying each type of separated rigid material. The film recycling line has a film grinding assembly and a hot washer apparatus and an agitation device for soaking the plastic film and mixing the plastic for additional washing, followed by a water bath for separating the debris and waste products from the plastic film. The film line also includes an agglomeration process that is performed in an apparatus that agitates a batch of film and results in the material to be further cut into small pieces of plastic, resulting in a course ground material that is capable of being transported along a screw-type conveyer mechanism to be transported to an extruder assembly. At least one extrusion assembly is included in the assembly, and preferably two extruders, wherein each extruder has a filtering mechanism to filter the extruded plastic material to further remove contaminants from the extruded plastic.

The invention also provides a universal shredding assembly with a universal shredding blade assembly, as an elongated shredding blade formed of a plurality of blade segments stacked together. Each blade segment has a central axis and an outer peripheral area with at least one cutter kerf extending to an outer edge of the peripheral area, the cutter kerf providing an exposed cutting edge. The cutting kerfs are arranged such that a kerf from one blade segment is aligned forward of a kerf of an adjacent blade segment, thus providing multiple sequential cutting edges along the blade length. These stacked blade segments combine to form a general spiral arrangement of cutter surfaces surrounding the axis of the assembly.

Another feature of the present invention is to provide a method of recycling plastic film material that includes shredding the plastic film and subsequently soaking and agitating the shredded film material and then subsequently separating debris and contaminants from the plastic in a water bath. This method provides highly washed and enhanced purity of the ground plastic being recycled.

In another aspect of the invention, the apparatus includes an agglomeration chamber with a mechanical forced movement of the material placed in the chamber and cutting blades that act against the material to further chop the plastic film material and create a course grind state of the material to be transported along a path directed toward an extruder assembly. In a preferred form of the invention, the agglomeration chamber is formed as a round drum configured to receive and process a batch of the plastic film material. An agitation blade is rotationally positioned at the bottom of the drum and a plurality of counteracting cutter blades (such as stationary blades mounted about the inner perimeter surface of the drum) subject the material to a cutting action to separate the plastic into small particles that form a paste-like state of the material. In the preferred process, a small amount of water is added to the paste material to break the paste into a course ground plastic that may be transported along a screw-type conveyer mechanism.

The invention further provides an apparatus and method for processing recycled plastic in a multi-stage extruder apparatus that has a first extruder with a filter screen and a second extruder with a second filter screen. Further, the invention provides for the pressure of the multi-stage extruder apparatus to be at least partially adjusted by a hot melt pump in line with the extrusion apparatus.

Other features and advantages of the invention will be apparent from the following specification, taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an initial stage of the apparatus according to the invention, depicting the initial shredding operation and the separate conveying of shredded material to the separate grinding apparatus;

FIG. 2A is a plan view of a cutter blade segment according to the present invention;

FIG. 2B is a perspective partially exploded view of the universal shredder blade assembly according the present invention;

FIG. 3A is an elevated perspective view of the water bath tank of the apparatus according to an aspect of the present invention;

FIG. 3B is an enlarged view of the terminal end of the water tank of FIG. 3A showing a segment of the terminal two rotating paddles of the apparatus of the invention;

FIG. 4 is an elevated view of a secondary stage of the apparatus according to a preferred form of the invention, showing an arrangement for the wash and separation process of the system for processing plastic film;

FIG. 5 is an elevated view of a secondary stage of the apparatus according to a preferred form of the invention, showing an arrangement for the wash and separation process for processing rigid plastic material;

FIG. 6 is an elevated view of a third stage of the apparatus according to a preferred form of the invention, showing an arrangement for the process of drying plastic film material;

FIG. 7 is an elevated view of a third stage of the apparatus according to a preferred form of the invention, showing an arrangement for the process of drying the rigid plastic material that is separated by collection at the top of the water bath;

FIG. 8A is an elevated block diagram view of a fourth stage of the apparatus according to a preferred form of the invention, showing an arrangement for the extrusion process of film material;

FIG. 8B is an elevated block diagram view of a fourth stage of the apparatus according to a preferred form of the invention, showing an arrangement for the extrusion process of rigid material;

FIG. 9 is an elevated view of an in-line extruder apparatus according to a preferred form of the invention;

FIG. 10 is an elevated block diagram view of the water channel and recycling system that is utilized in a preferred form of the apparatus according to the invention in the Figures;

FIG. 11 is an elevated transparent view of the hot washer according to the present invention, with the internal components of the washer shown as if transparent to reveal the inner parts of the washer;

FIG. 12 is a side sectional view of the high-speed agitation device according to an aspect of the apparatus, taken along lines 12 in FIG. 4;

FIG. 13 is a block diagram view of the process and apparatus according to the present invention;

FIG. 14 is an elevated perspective view of the agglomeration assembly according to the present invention and an example of an assembly that may be used in accordance with the agglomeration process of the invention;

FIG. 15 is a side view of a lower portion of the agglomeration assembly shown in FIG. 14, with a partial cutaway of the sidewall of the agglomeration chamber of the assembly; and,

FIG. 16 is a perspective view directed downward into the top opening of the agglomeration chamber according to the present invention, with the sidewall of the chamber shown with curve shading and the bottom wall of the chamber located within the center ring below the sidewall.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides an assembly and a system for recycling plastic waste products of different types, including plastic film, such as film made of polyethylene or polypropylene, or rigid plastic waste that includes polypropylene, polystyrene, and/or PET and which also often includes metal contaminants. A significant aspect of the invention is the ability to produce recycled plastic material that is highly pure and thereby very useful in manufacturing products, including consumer products such as food containers and the like. This has not been available with conventional processes and equipment. Another significant aspect of the invention is to provide an apparatus that is capable of processing either film or rigid material in a manner that utilizes a common initial grinding apparatus and a common water bath assembly. Thus, recycled plastic material produced according to the present invention has heretofore not existed and, thus, is an improvement over conventional recycled plastic material.

The apparatus 10 according the present invention, as shown in the Figures, preferably utilizes a single plastic waste intake 12 that introduces the waste material to an initial universal shredder 14. In the preferred form, the intake includes a conveyor belt 16 that extends at an incline to elevate the waste material W to be fed into an open top of the universal shredder 14. As the waste material W is shredded in the universal shredder 14, the shredded plastic material 18 is delivered to a conveyor assembly 20 positioned adjacent the shredder 14, preferably as a reversible conveyor belt 22 under the shredder 14. The reversible conveyor 22 is configured to move in a first direction toward a plastic film recycling line 24 and alternatively in a second direction toward a rigid plastic recycling line 26. This is a central feature of an aspect of the invention, wherein the plastic material W is processed into a recycling apparatus and method, by first shredding the waste material in an initial shredder 14, and wherein the conveyor transporting the shredded material 18 is connected to at least a plastic film recycling line or a rigid plastic recycling line. Thus, according to this aspect of the preferred embodiment, the waste material being recycled is subject to a pre-grinding process in which the waste material is shredded, and wherein the assembly performing the shredding is a universal shredding device 14 rather than requiring separate shredder assemblies for each type of plastic waste material W.

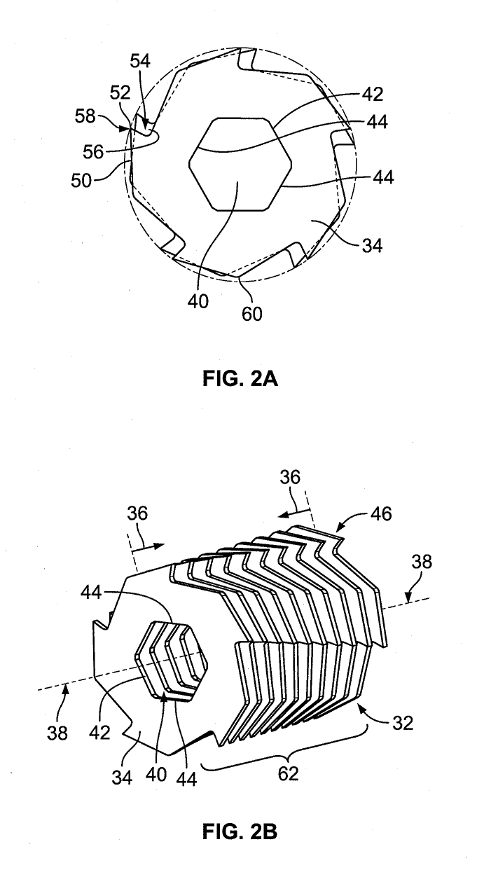

The universal shredder 14 has a shredder housing 30 with a rotational shredder blade assembly 32. The unique structure of this blade assembly 32 is configured to provide a blade design that is useful for shredding all types of plastic materials, including the plastic of film material and rigid material. As is shown in FIGS. 2A, the shredder blade assembly 32 is preferably formed as an elongated blade formed of stacked blade segments 34, the blade segments 34 being stacked together to form a blade length 36 from a first blade segment 38 to a terminal blade segment 40, which substantially fills an inner dimension of the shredder housing 30. The blade assembly 32 of stacked segments 34 also has a central axis 38, residing about a central opening 40 configured to receive a drive shaft of a drive mechanism (not shown). In the preferred form of the invention, the central opening is formed with a curvilinear inner edge 42 that is configured to provide indexing of the blade—that is, to provide a locking feature wherein the blade assembly is inserted along the drive shaft with mating surfaces such that the blade assembly and the drive shaft rotate together in unison, generally not requiring the blade assembly to be welded or otherwise fixed to the drive shaft. In the preferred embodiment shown in the Figures, such indexing is provided by the central opening 40 having inner edges 42 formed as a parallelogram. Significantly, the inner edge 42 of the central opening 40 has even numbered opposed segments 44, here shown as the straight portions of a hexagon. Of course, the opposed segments 44 shown in the Figures may instead be curvilinear portions of the central opening 40, provided that, in the preferred embodiment, the opposed segments are identically shaped so the blade segments 34 may be stacked together with a central opening 40 that receives the drive shaft. This feature, which is additionally described below, significantly allows for the blade assembly 32 to be formed of stacked segments 34 that are simply inserted along the drive shaft together such that adjacent blade segments 34 are rotated relative to one another when stacked together in the assembly 32. This provides a rotational orientation of the cutting teeth 46 of the blade segments 34, which together form a generally spiral arrangement of the cutting teeth 46 about the blade assembly 32 along at least a portion of the blade length 36.

Each blade segment 34 preferably is formed as a generally flat metal blade having an outer edge 50 such that the outer cutting teeth 46 extend to the outermost peripheral edge 52, preferably having all of the cutting teeth 46 reside in the same circumferential region of a circular outer peripheral edge 50. The cutting teeth 46 are formed as a cutting kerf 54 that includes an inward notch 56 and a protruding cutting edge 58. The outer edge 50 of the blade segments 34 also include a plurality of protruding blunt kerfs 60, preferably positioned between adjacent cutting kerfs 54 about the outer edge 50. The blunt kerfs 60 preferably do not extend to the outer peripheral edge and, thus, are configured to mix material being shredded in the shredder assembly 14 without acting as a shredding blade surface of the blade assembly 32.

Each blade segment 34 of the blade assembly 32 is preferably positioned in a rotational orientation relative to an adjacent blade segment 34, such as is shown in FIG. 2A. As a result, the combination of the blade segments 34 attached together, as shown in the Figures, provides a combined cutting edge 62 that is non-linear along the length 36 of the assembly 32. In the preferred arrangement, the non-linear cutting edge 62 is arranged in a twisted or generally corkscrew path along the length 62 of the shredder blade 32. One arrangement for construction of such a shredder blade 32 is provided by a central opening 40 of each segment 34 having an indexed inner edge that is symmetrically configured such that the segments 34 may be rotated relative one another when inserted along the drive shaft. As an example, the arrangement of an even number of opposed segments 44 of the inner edge 42, along with an odd number of outer cutting kerfs 54, is configured to provide altering arrangement of the cutting kerfs 54 about the central axis 38 when mating the inner edge 42 of the central opening 40. Thus, as shown in FIG. 2B, the inner edge 42 of the segments 34 are aligned together as a mating surface of the central opening 40 of the assembly 32 while the cutting kerfs 54 of adjacent segments 34 form a combined cutting edge 62 that is generally spiral about the axis 38 of the assembly 32. The spiral arrangement of the combined cutting edge 62 of the cutting teeth 46 is configured to provide a universal shredder blade 32 which is adapted to shred pliable plastic film material in the housing 30, and is also adapted to shred rigid plastic waste in the housing 30. This is achieved primarily by having a spiral cutting edge that will progressively shred the waste material against the inner walls of the housing 30 with rotation of the blade assembly 32, and with blunt kerfs 60 mixing the waste material between shredding actions by the cutting edges as the assembly 32 is rotated about its axis 38.

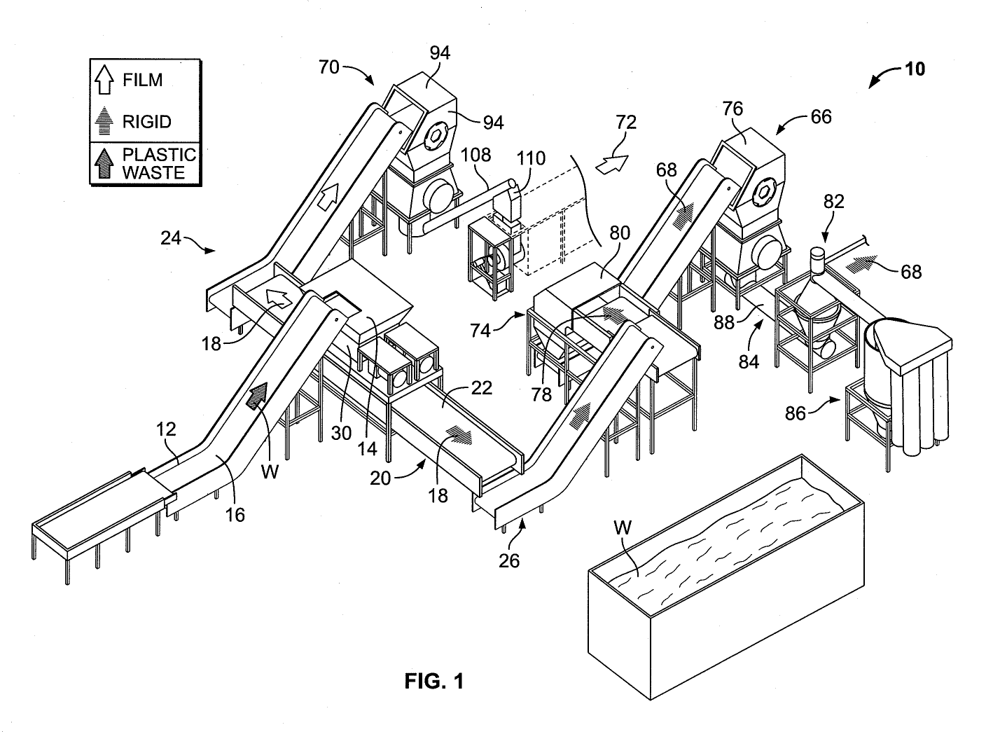

The shredded material 18 exiting the shredder 14 is transported by a conveyor assembly 20, such as by dropping on the reversible conveyor belt 22, as shown in FIG. 1. The conveyor belt 22 is configured to direct the shredded material 18 toward a rigid recycling line 66 for processing rigid plastic material 68, or to direct the shredded material toward a film recycling line 70 for processing film plastic material 72. Thus, in the preferred form of the invention, the assembly 10 operates to process either rigid plastic 68 or film plastic 72, depending on the type of waste material W at the intake 12. In each of the two recycling lines 66, 70, the plastic material proceeding through the line is subject to a recycling process that preferably includes grinding of the material in a grinder apparatus. Prior to grinding, the plastic processed in either or both of these lines 66, 70 may be subject to a metal separation assembly 74, as shown in FIG. 1, in the rigid plastic line 66, positioned after the universal shredder by prior to the rigid material grinder 76. In this embodiment shown, the metal separation assembly 74 includes conventional metal separation devices, such as an Eddy Current metal separation unit 78 and a ferrous metal separator that preferably utilizes magnetic separation of the metal.

It is advantageous for the rigid line 66 to also provide an in-line fines separator 82 to filter out the fine plastic material that includes dust of plastic material difficult to process in the recycling system because the particle size is too fine for conventional techniques. In the preferred form of the apparatus 10, the fines separator 82 is positioned directly in line with the rigid recycling process, and consists mainly of a blower assembly 84 and a fines filtration unit 86. Having this apparatus in line with the feed of the rigid material 66 provides an assembly 82 that positions the fines collector 86 in line with the air flow from the blower 84, which is also preferably in line with the direction of the material transported from the rigid material grinder 76 through the passageway 88 positioned below the grinder 76.

As can be appreciated by the Figures, including FIGS. 1, 4-5 and 12, the film line 70 and the rigid line 66 separately branch in directions from the initial shredding operation to process the plastic material passing through the apparatus 10, and the lines preferably each feed into a single water bath 90 for further processing the plastic in the steps of recycling. Thus, it is another significant aspect of the assembly to provide a single universal shredder 14 joining separate processing lines 66, 70 that utilize the efficiency of a single water bath 90 in the apparatus 10. This provides an advantage of utilizing equipment for multiple purposes, i.e., processing rigid or film plastic, and conserves energy and resources of clean water supply in suitable amounts for processing each type of plastic material 72, 78. Thus, one aspect of the invention provides a method of recycling plastic material that utilizes this combination of the steps of initially shredding plastic waste material W, such as in a universal shredder, and processing the material through a recycling system configured to separately prepare rigid material 68 and film material 70 for passing through a common water tank 90 as a step of the recycling process.

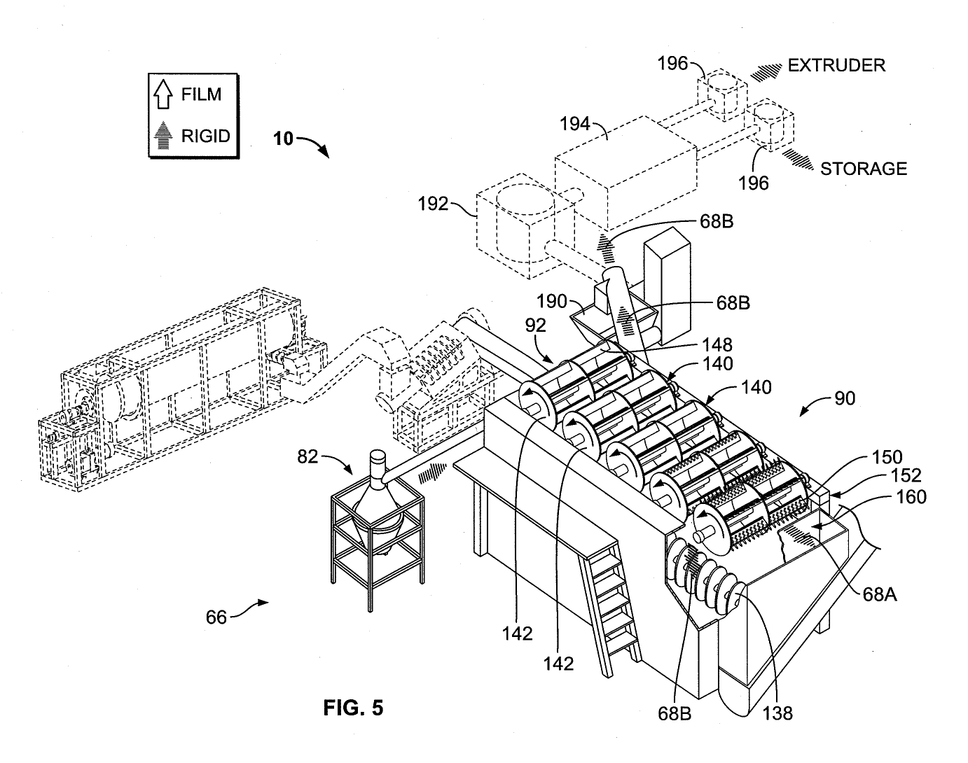

In the preferred embodiment of this aspect of the invention, as shown in FIGS. 1 and 5, the rigid material 68 exits the rigid grinder 76 and, subject to separation of the fines separator 82, enters the water tank 90 (which is substantially filled with water) at a first end 92 of the tank 90.

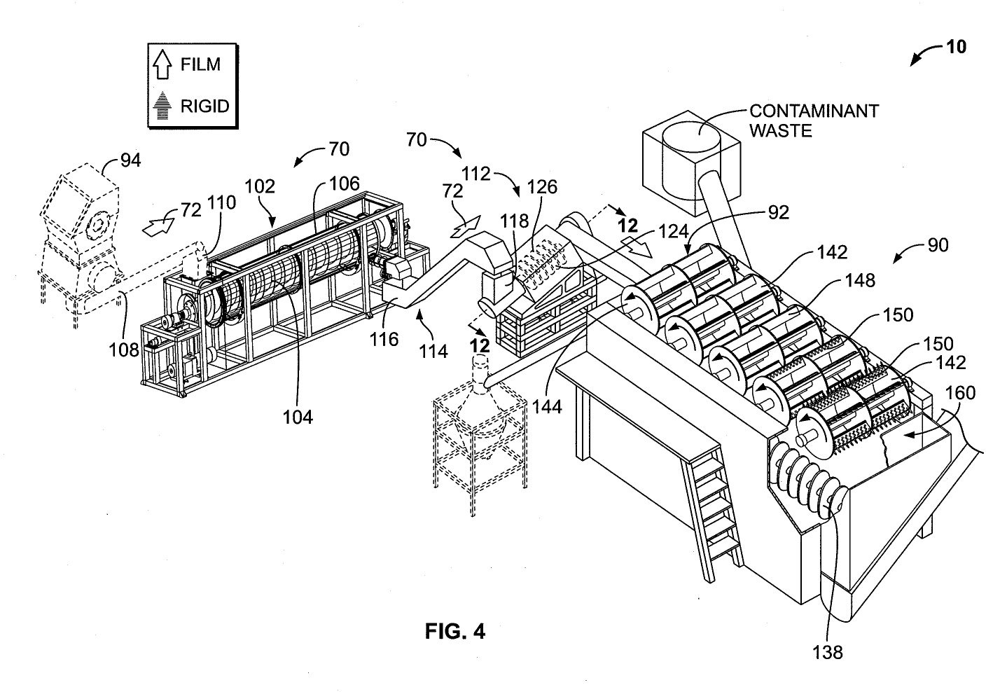

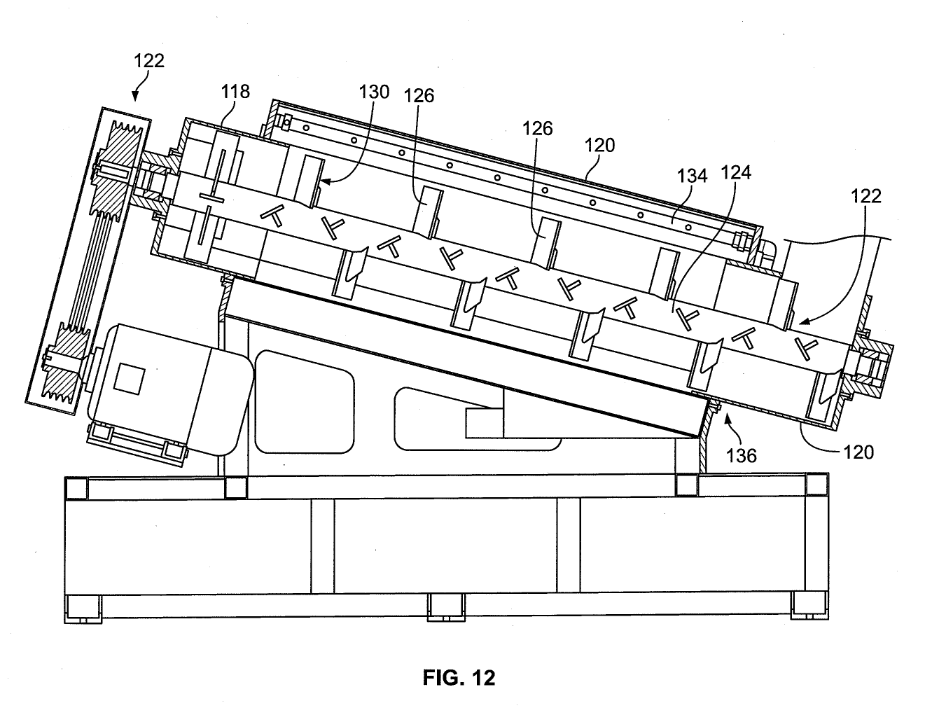

Similarly, in the plastic film line 70, the film material 72 exits the film grinder apparatus 94 and eventually is placed in the water tank 90, preferably at the first end 92 of the tank 90. This is the manner in which the method and apparatus of the present invention utilizes the same water bath 90; however, it is advantageous for the film to be subjected to additional water washing processes that are unique to this system. In a preferred form of the invention, the system and method of the recycling process of the apparatus 10 includes a water wash process 100 that is depicted in FIGS. 4 and 12, which includes a hot water soak apparatus 102 for the step of introducing heated water to the film material 72.

The hot water soak apparatus 102 preferably includes a mixing operation with the introduction of hot water, such as is achieved with a screw-type drive mechanism 104 inside a washer housing 106 of the washer apparatus 102. In this manner, the plastic material 72 passes from the film grinder 94 through a transport duct 108 to a washer in-feed 110. Once inside the washer apparatus 102, heated water, preferably to a temperature in the range of 150 to 100 degrees Fahrenheit is introduced into the housing 106 to mix with the material 72. The screw mechanism 104 then turns the wet material 72 inside the housing 106, causing the heated water to mix with the material for a thorough wash of the plastic with the heated water. In a preferred form of the invention, the housing 106 of the hot washer 102 includes an outer drum 105 which rotates at an opposite direction from the inner drive 104. Preferably, the outer drum 105 rotates at a slow speed in the range of approximately 6 revolutions per minute and the inner drive 104 rotates at a more rapid speed of approximately 40 revolutions per minute. This rotation of the components of the washer 102 enhances the mixing operation within the hot washer to assure the plastic material 72 is thoroughly soaked with the hot water.

The next step of the water wash process 100 is for the material 72 exiting the hot washer 102 to be mixed in an agitation process 110 in a high-speed mixer apparatus 112. The plastic film material 72 is preferably transported from the hot washer 102 to the mixer 112 via a wet material conveyor system 114 that has a hosing 116 with an internal conveyor (not shown). The wet-material conveyor 114 transfers the material from an end of the washer housing 106 to an in-feed hopper 118 of the mixer 112. The wet material 72 then enters the body 120 of the mixer which houses a mixing drive 122.

In the preferred form of the invention, the mixing drive 122 includes an elongated central drive shaft 124 and a plurality of angular surfaces 126 along an extent of the drive shaft 124. As shown in FIG. 12, the preferred form of the invention includes a mixing drive 122 that has angular surfaces 126 formed of projecting flaps 130 or flights that protrude radially outward of the mixing drive shaft 124. In the preferred form of this aspect of the invention, the mixing is performed in an operation in which the mixing drive rotates at approximately 1500 revolutions per minute to clean the wet material 72 of impurities, such as paper or the like. The mixing drive 124 also is preferably positioned at an incline, to increase the agitation of the material 72 as it is forced against gravity, and the apparatus 112 preferably includes a water spray assembly 134 that introduces additional water to increase water washing during the agitation process 110, with a drain assembly 136 included to drain the water used to wash through the material 72.

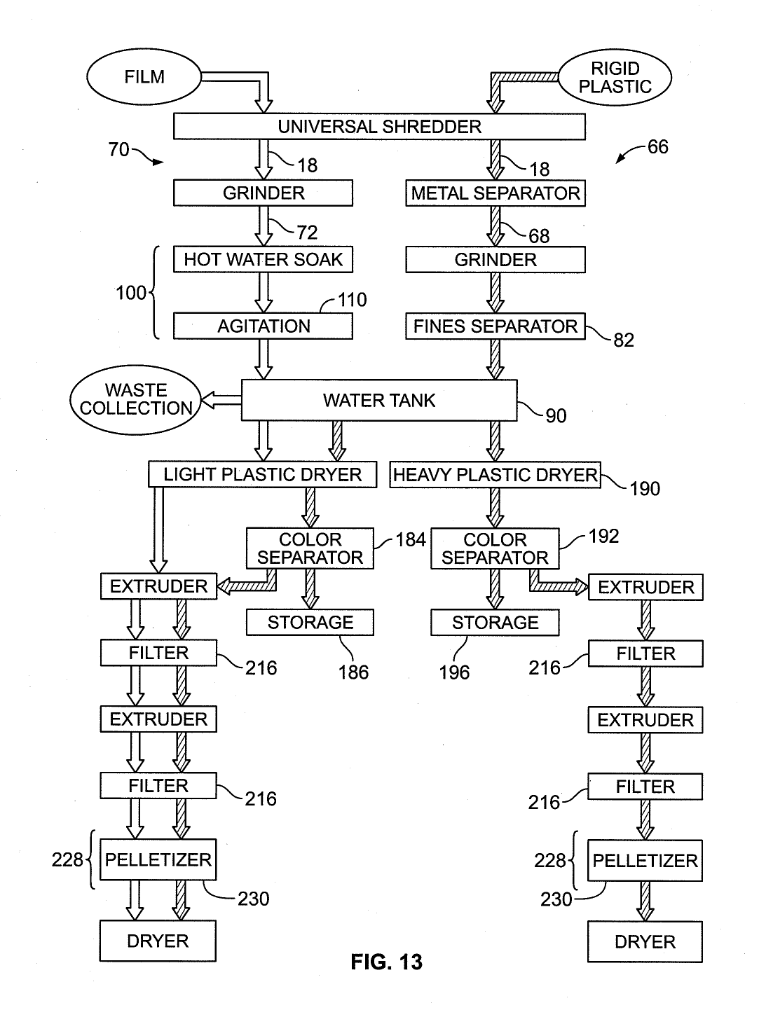

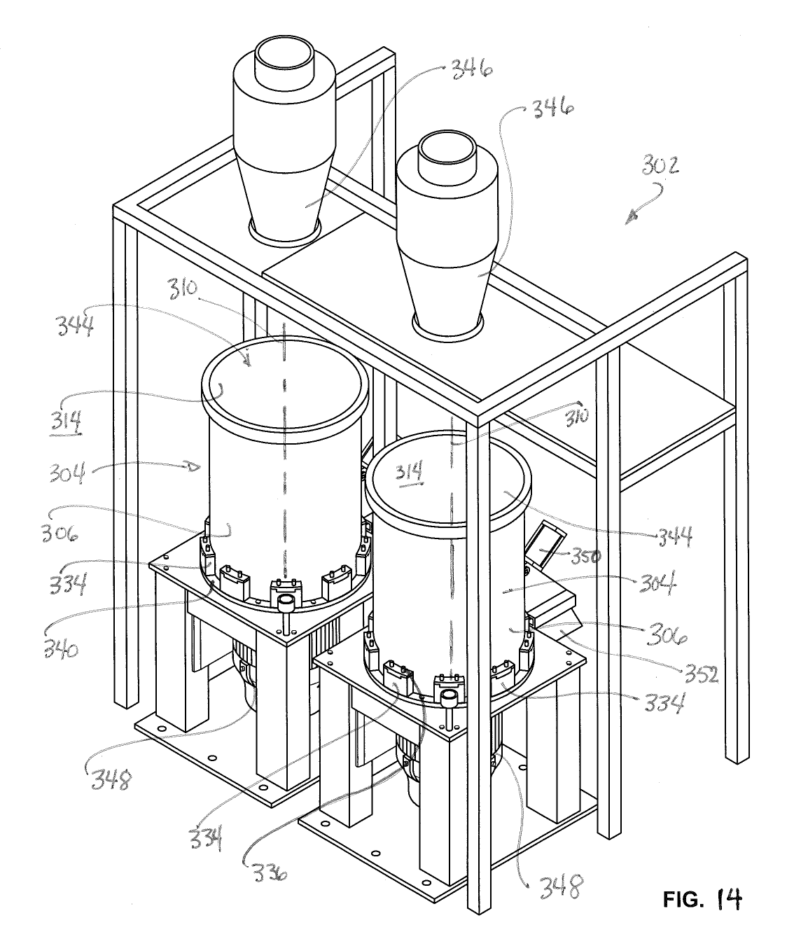

The next step of the film line 70 is for the film material 72 exiting the water wash process 100 (the hot washer 102 and the agitation by the mixer 112) is inserting the material into the water tank 90 at a first end 92. The film material 72 inside the water tank 90, because of its density properties, floats in the top area of the water in the tank 90. Contaminants in the film material, such as paper which has been saturated by the water wash process and the time in the water tank, sinks to the bottom of the tank 90, towards the bottom transfer mechanism which, in the preferred embodiment, is an elongated screw drive mechanism 138 located near the bottom of the water tank to capture and move the sinking material along the length of the tank 90. Preferably, the screw drive 138 rotates in a direction to force the material within the screw drive back toward the first end 92 of the tank 90. The film material 72, which has them been washed of contaminants by the water pre-soaking, agitation, and the water soaking during the time spent in the water bath tank 90, is then transferred from the water tank 90 into the remainder of the process, as described herein. Significantly, this combination of processes of the water wash 100 and the time passing through the water bath tank 90 is one of the key aspects of the present invention, as the purity of the plastic material created by the process is much greater than achieved through conventional recycling processes and equipment. In the preferred form of the invention, the film material 72 is then subject to another grinding process prior to being stored or being extruded in an extrusion process. This additional grinding process, which is described in detail below in relation to the agglomeration process 300 and shown in FIGS. 13-15, transforms the state of the film 72 from the wash processes, which tends to be a sticky plastic film material that is susceptible to clumping and thereby difficult to transport and dose. The product of the agglomeration process 300 is a film material 72 that has been transformed into a course paste of ground plastic film that is capable of being transported along a screw type conveyer and is less likely to clump into a mass of plastic such as may occur with the highly purified plastic film material 72 form the multiple wash process.

When the apparatus 10 is processing rigid plastic 68 instead of film material 72, such that the rigid line 66 is operational, the rigid material 68 is introduced into the tank at the first end 92 of the tank 90. In the tank 90 of water, the less dense plastic material floats near the top of the tank 90, whereas the dense plastic material sinks to the bottom toward the screw drive assembly 138. Thus, the rigid plastic that is inserted into the water bath tank 90 separates according the density of the material, with plastics such as polypropylene and polyethylene rising to the top and material such as polystyrene and PET sinking to the bottom. In this manner, the less dense plastic material 68A remains at the top of the water and separately the dense plastic material 68B will sink to the bottom, such that the two are independently purified as the process continues and the two are separately transferred from the water bath tank 90 as described herein. As shown in FIG. 5, the material that sinks is gathered along the bottom of the tank by the screw drive 138, and the floating material, as discussed below, is converted along to exit at the top of the tank 90.

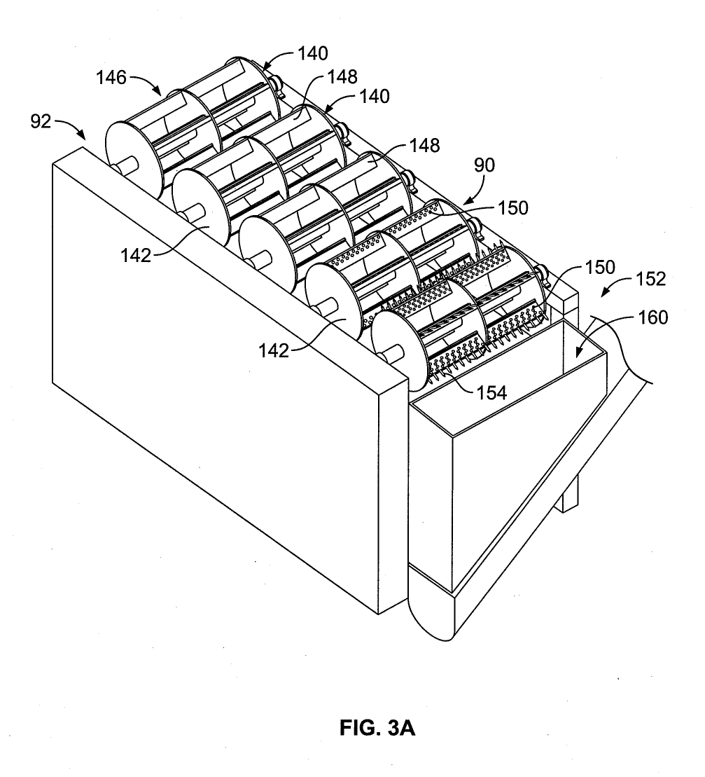

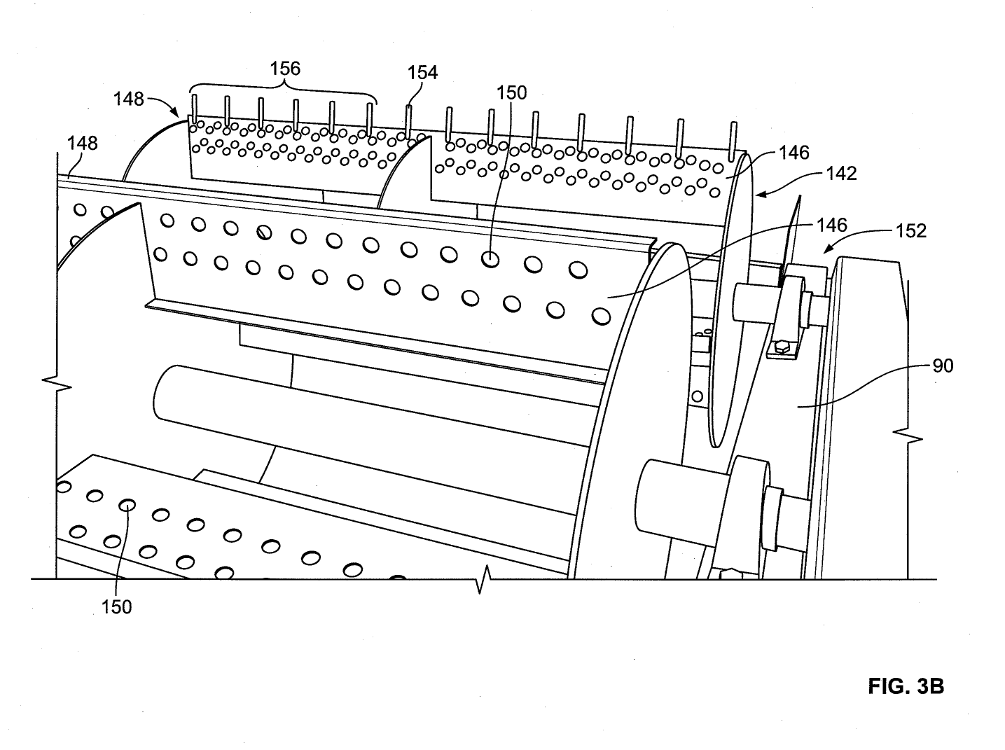

The water bath tank 90 includes a skimming apparatus 140 which resides at the top of the water tank 90 to urge the floating plastic material along the length of the tank 90. In the preferred form of the invention shown in the Figures, the skimming apparatus 140 is comprised of a series of paddle wheels 142, each having a length that spans substantially the width of the tank 90. The paddle wheels 142 are configured such that a first paddle wheel 144 is positioned adjacent the first end 92 of the tank 90, shown as the left side of the tank in the Figures. The paddle wheels 142 in this arrangement rotate counter-clockwise such that a leading face 146 of each paddle segment 148 pushes into the water and along the upper surface of the water in the tank 90. As the paddle wheels are preferably partially submerged in the water of the tank 90, the material is moved along the length of the tank 90 with minimal resistance. In the preferred form of the assembly 10, the first group of paddle segments 148 passing through the water at the first end 92 are generally solid and flat surfaces, such as shown in FIG. 3A. In contrast, a subsequent set of paddle segments 148 of the paddle wheels 142 have perforations 150 that allow water to pass through the segments when the wheel is rotated. This arrangement provides an apparatus that is configured to provide a varying degree of turbulence on the water of the tank 90 such that the initial paddle wheels act against the water in the tank 90 to turbulently mix the floating material with the water, whereas the perforated paddles at the latter part of the assembly, approaching the terminal end 152 of the tank 90, are configured to move the material along with less turbulence on the water in the tank 90.

In the preferred embodiment, the paddle segments at the terminal end 152 of the bath tank 90 include a plurality of outwardly-extending stems 154 which collectively are configured as a rake structure 156 protruding from the outer portion of the paddles 148 along at least an extent of the length of the paddles 148. Additionally, the paddles of the final paddle wheel assembly at the terminal end 152 preferably has many perforations 150 to provide an even greater amount of the paddle being open for water to pass through relative the other paddles, thus being configured to move the floating plastic without causing much turbulence to the water. This arrangement of numerous openings in the surface of the paddle wheels 142 that reside near the terminal end 152 of the tank 90 provides structural features that increase the ability for the paddles to move material through the final part of the tank 90 and into the hopper 160 at the end of the bath tank 90. The hopper 160, therefore, receives the less dense rigid plastic material that floats in the water bath tank 90 when the rigid line 66 is in operation, or it receives the plastic film material 72 that has been washed and separated from contaminants such as paper in the water bath tank 90 when the plastic film line 70 is in operation.

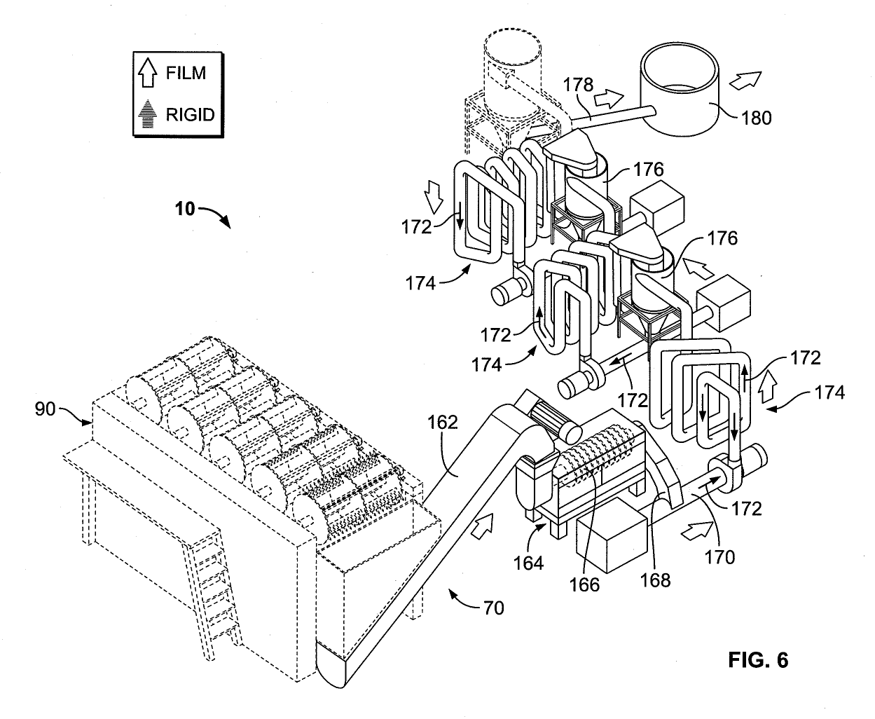

The cleaned/separated plastic material that is loaded into the end hopper 160 is ready for the next stage of the process—the drying process that precedes extrusion of the plastic. The drying process preferably includes the steps of first straining water from the plastic material in the hopper 160, spinning the material to remove additional water, and then subjecting the material to air drying for final removal of moisture on the surface of the plastic. Keeping with the objective of the invention to practice a method of creating a highly purified recycled plastic material by thorough washing and separation of the plastic material form other materials, the present invention provides a complete drying step to result in a final ground recyclable material that is substantially free of moisture. As shown in FIG. 6, this process preferably utilizes a spin dryer apparatus 164 that is linked to the hopper by a drying conveyor 162. The spin dryer has includes a rotational inner drum 166 that is configured to drain loose water from the plastic material received from the hopper 160. The material exits the drum 166 of the spin dryer 164 and passes through a dryer in-feed duct 168 that terminates in communication with an elongated air blower passageway 170, such that the material passing through the in-feed duct drops into an air stream 172 within the passageway air blower 170.

The blower passageway 170 is preferably a substantially closed system that includes partial ventilation along its path through its length, and terminates at a final location for collecting the plastic material. Along that path of the elongated blower passageway 170, different arrangements of the passageway are included to mix the material being dried, including bends and undulations of the passageway 170, such as with the coil segments 174 shown in FIG. 6. In the preferred form of the process, the apparatus includes the ability to subject the material in the air stream 172 to three coil segments 174 to tumble the plastic in the airstream 172 for thorough removal of moisture from the plastic material. Further, as shown in FIG. 6, this drying process preferably includes feeding the material in the air stream 172 through at least one cyclone chamber 176 positioned between coil segments 174 that generally urges the air stream 172 into a spiral or cyclone-like path to continue on the adjacent segment of the passageway 170. In a preferred form of the invention shown in FIG. 6, multiple cyclone chambers 176 are provided, also as part of the unique aspect of the invention to substantially remove all moisture from the plastic material.

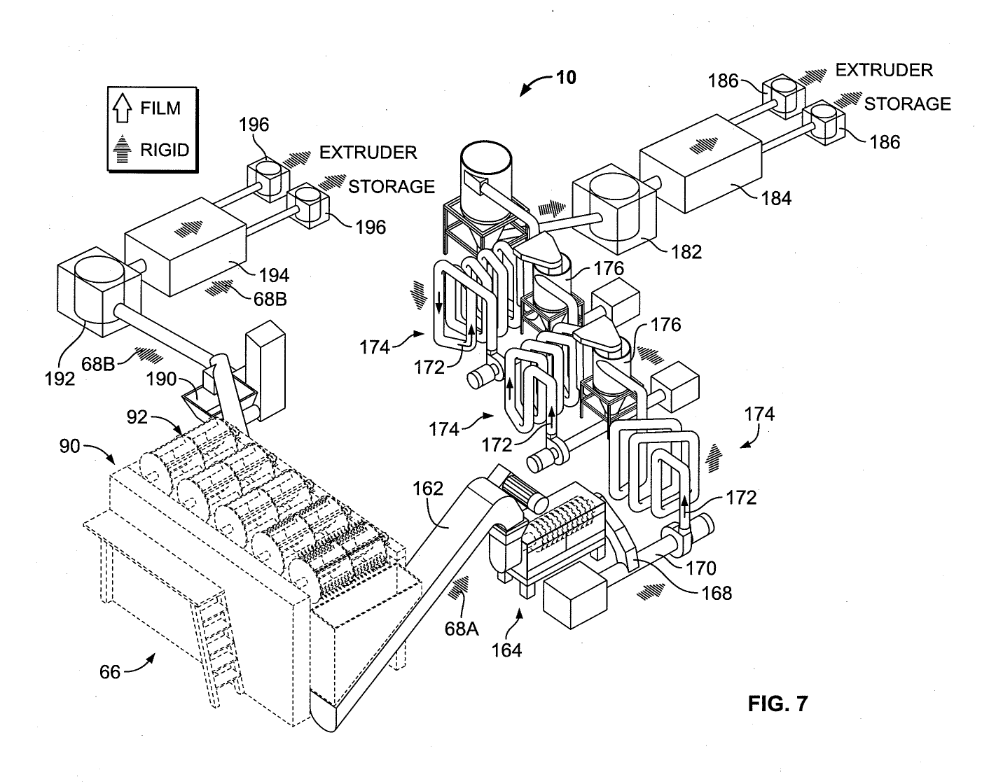

The material passing through the blower passageway 170 exits the terminal end 178 and, depending on the material being processed, is collected for the final step of the recycling process—extrusion. When the film line 70 is in operation, as shown in FIG. 6, the material preferably is passed into a first regrind storage container 180. This is used as a staging location for collecting the material to be extruded in the final step of the recycling process. When the rigid line 66 is in operation, the less dense material is collected in a second storage container 182, and then conveyed to a color separator unit 184. The color separator mechanically separates the ground plastic material, such as with conventional devices for this operation, and the separated colors are delivered to storage containers 186 for collecting the plastic for further processing. In the preferred form of this process, as shown in FIG. 7, the plastic collected in one of the containers 186 is sent to the extruder operation, while the other is collected in storage for extruding later.

This is a significant aspect of the invention in that, while the rigid line 66 is operational, a separate simultaneous extruder process is carried out for both the less dense material that is dried in the blower passageway 170 and the dense material from one output of the color separator 184. Specifically, FIGS. 5 and 7 show the paths of the rigid material 68 passing through the system after separation of the material in the water bath tank 90, separating the less dense material from the dense material. When the rigid line 66 is in operation, the material collected along the top of the water bath tank 90 is collected and passes through the air blower passageway 170 for drying, as explained above. The more dense material that is collected by the screw drive mechanism 138 at the bottom of the water bath tank 90 is collected and passed into a centrifuge dryer apparatus 190 to remove the water and moisture from the plastic material. The material exiting the dryer apparatus 190 is then collected in a collection container 192 for introduction into a color separator 194 for separating at least two different colors of the dense rigid material, utilizing conventional color separation technology and devices. Preferably, the separated materials are transferred to collection containers 196, one for collection and storage of the material, and the other for transferring material to an extruder line, as shown in FIG. 5.

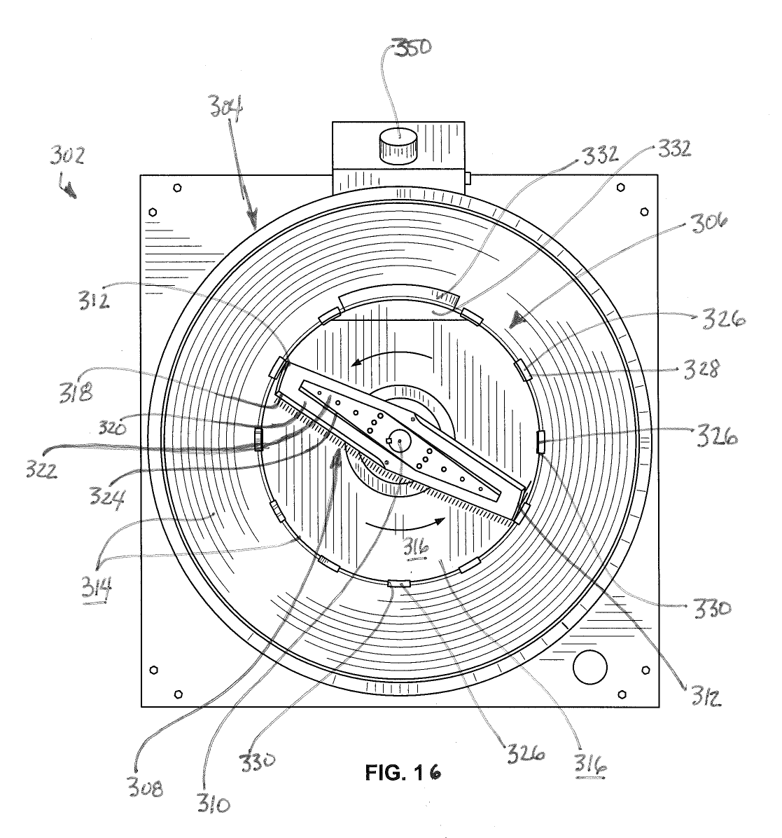

In an embodiment of the apparatus 10 and process according to the invention, the plastic film line 70 includes an additional process step, an agglomeration step 300, that is performed in an agglomerator apparatus 302, which (with reference to FIG. 13) takes place after the light plastic dryer and prior to the extruder(s). As shown in FIGS. 14-16, the agglomerator apparatus 302 is preferably comprised of at least one (and preferably two) agglomeration chamber 304. Each agglomeration chamber 304 has a large housing with a cylindrical body portion 306 that is configured to receive a volume of plastic film material 72, as a bulk batch, after the material 72 has been through the wash processes in the hot washer 102 and the water bath 90, and preferably after the drying step in the blower passageway 170 and cyclone chamber(s) 176. Therefore, the film material 72 that is batch delivered to the agglomeration chamber 304 is preferably substantially dry washed film material 72 that is otherwise prepared to be fed into the extruder lines 202, 204, such as by way of being delivered to an intermediate storage container 180 and then progressing to one or more of the extruders 202, 204. Accordingly, the film line 70 includes the structure and process for transferring the film 72 exiting the drying process of the blower passageway 170 to the agglomerator apparatus 302. Examples of such delivery mechanisms and structures include conveyer tread systems, screw-type conveyers, paddle conveyers or batch delivery systems.

In a preferred form of the invention, the film material 72 is delivered directly to the agglomerator 302 from the dryer assembly including the blower passageways 170, thus not requiring the intermediate step of being housed in a holding container, such as the storage container 180. Alternatively, the material 72 may be transferred to a storage container such as disclosed, 180, and is pooled and subsequently transferred to the agglomerator apparatus 304. In either operational mode, whether material 72 is transferred directly from the prior steps of the process line 70 or from the storage container 180, the agglomeration step 300 is preferably performed as a batch-process that utilizes multiple agglomerator chambers 304. This is primarily due to the running time required to process a batch of plastic film material 72 in an agglomeration step 300, such that the resulting material has the appropriate and desired physical properties that enable transport and storage of the material for eventual extrusion in an extruder. Utilizing multiple chambers 304 allows the agglomeration process 300 to be operational and directly receive an in-line feed from the preceding operational steps of the film line 70. In other words, because the material 72 dried in the blower passageway 170 is continuously exiting from the terminal end 178 of the passageway, the dried material is alternately delivered to each of the chambers 304 of the agglomeration process 300. Thus, use of multiple chambers 304 allows for the material 72 in one chamber to be processed and emptied while the other chamber 304 is being filled.

The process of agglomeration 300 that takes place within each chamber 304 is essentially an agitation and cutting operation, starting with substantially dry film material 72 that has been through the washing process and resulting in a course paste-like state of the material 72 that is a substantially flowable material, capable of being transferred to the extruders by a screw-feed mechanism or a similar form of transferring material into an extruder. In a preferred form of the invention, the process of creating the flowable material may be facilitated by the addition of a small amount of water relative to the volume of the material 72 as the agitation force is applied to the material 72 within the chamber 304 of the agglomerator 302. The addition of a small amount of water will provide enough moisture to separate the compact paste material into a more course paste structure that is capable of being transported along a screw-type conveyer line.

The action of the agglomerator 302 to transform the material 72 entering the assembly 302 into a paste-like state is caused by the rotational agitation blade assembly 308 located in the central portion of the cylindrical body 306 of the chamber 304. The agitation blade assembly 308 is preferably located at the bottom of the chamber 304 and is driven into rotational movement about a central axis 310. In a preferred form of the invention, the agitation blade assembly is rotated in a counter-clockwise direction, with the outer terminal ends 312 of the blade assembly 308 approaching and immediately adjacent the inner surface 314 of the chamber 304. A bottom wall 316 of the chamber 304 is immediately below the agitation blade 308 and the agitation blade 308 preferably has at least one inclined surface 318 that slopes upward and angularly relative to the bottom wall 318. In the preferred form of the assembly 302, the agitation blade 308 has a main body segment 320 with the angular surface 318 along at least a portion of its extent, and has a second body segment 322 residing above the main body segment and includes a second angular surface 324 along an extent of the length of the second body segment which also extends upwardly and angularly relative to the bottom wall 316.

Rotational movement of the agitation blade assembly 308 pushes the material 72 within a chamber 304 along the rotational direction and radially outward along an extent of the length of the blade 308. At least one stationary blade 326, and preferably a series of several stationary blades 326, are positioned along the inner surface 314 of the chamber 304 and reside adjacent the outer ends 312 of the blade assembly 308 as it rotates about the axis 310. The stationary blades 326 are preferably formed of a body 328 having a kerf edge 330 formed from an angular surface of the body 328. As the rotational agitation blade 308 is driven in counter-clockwise rotation, the material 72 is forced against the kerf edge 330 of the stationary blade(s) 326, such that the material 72 is chopped up and mixed. Continued rotation of the blade assembly 308 forces the additional material 72 to be chopped against the stationary blade 326, eventual transforming the washed film material 72 into a course paste-like plastic state of the material. In the preferred form of the process 300, a small amount of water is added to the material, which then causes the paste to partially separate into definable chunks of material that may be transferred out of the chamber 304 in a substantially flowable state for forcing into an extruder by a screw-type drive mechanism. For example, when processing a 150 pound batch of film material in the chamber of the agglomeration process assembly, approximately 500 milliliters of water may be added to transform the compact paste form of the material into a course paste-like state that is suitable for transport along a screw-type conveyer system, and is prevented from tightly compacting and being unmanageable and/or inseparable.

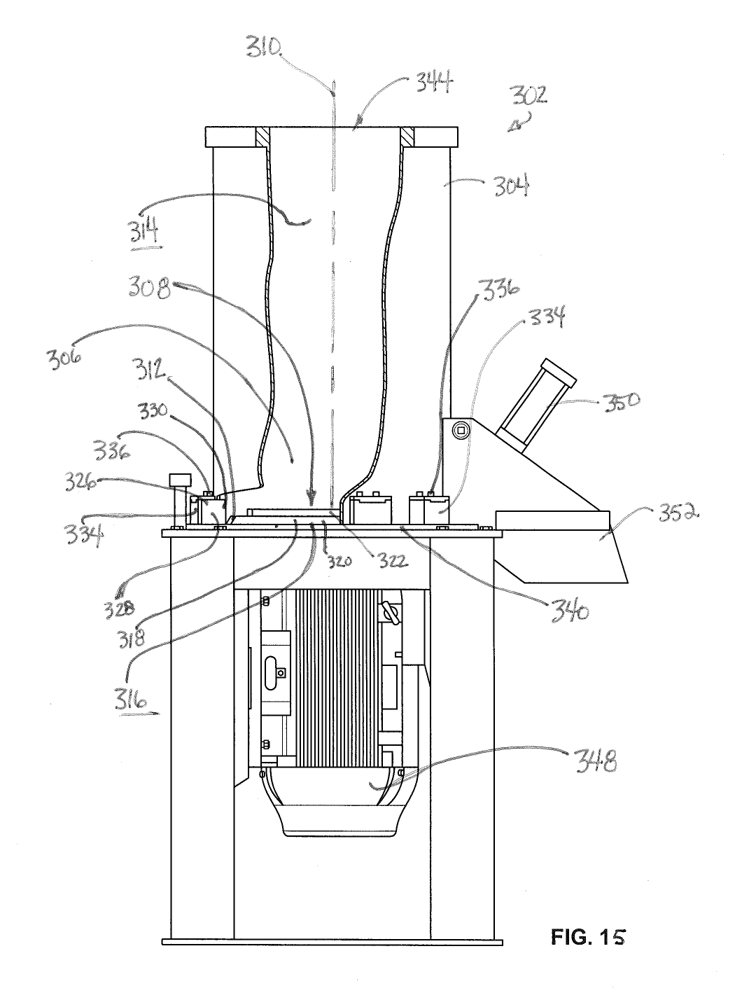

In the preferred embodiment, as shown in the Figures, there are several stationary blades 326 positioned generally equally-spaced distance from another along the inner wall of the chamber 304. In the embodiment of the Figures, there are eleven such stationary blades 326 substantially evenly spaced along the bottom of the chamber 304, with a space along an extent of the chamber 304 not including a cutter. The absence of a stationary blade in a portion of the chamber 304 provides a space for a moveable trap door 332 for emptying the chamber 304. As shown in FIG. 15, each stationary blade 326 has a generally square or rectangular shape body 328, with a portion of the body 328 residing in a blade housing 334, and the body 328 of each blade 326 extends through the wall of the chamber 304. At least one fastener 336, and preferably a plurality of fasteners, attaches the stationary blade 326 in position within the housing 334, preferably using a threaded type fastener 336 that extends through the housing 334 and the blade body 328 and is removably secured to a portion of the base 340 of the apparatus 302. This arrangement of the threaded fastener 336 of the stationary blade 326 allows for replacement of a particular blade 326 and for sharpening the blades if desired, such as to maintain a kerf edge 330 with a desired angle, preferably an angle in the range of 30 to 60 degrees.

In operation, the agglomeration apparatus 302 receives a bulk of material 72 at an open end 344 of the chamber 304, preferably delivered through at least infeed chute 346 positioned above the open end 344. The infeed chute 346 is in communication with the dryer apparatus such that the material 72 from the terminal end 178 of the blower passageway 170 passes to the infeed chute 346. The material 72 may be fed directly into the respective chamber 304 or the infeed chute 346 may be used as an accumulation chamber, such that a given amount of material may be measured (or weighed) for determining the appropriate amount to be administered into the chamber 304. In a preferred form of the process 300, approximately 150 to 200 pounds of material 72 passing into the infeed chute 346 is delivered to the chamber 304 for processing as a batch through the agglomeration apparatus 302. In this arrangement, the infeed chute 346 is configured to include a moveable gate (not shown) for opening the chute 346 and allowing the material to pass into the chamber 304. The agitation blade assembly 308 is driven in its rotational movement by a drive mechanism, preferably a direct-drive motor assembly 348, positioned below the chamber 304 just below the bottom wall 316 of the chamber 304. Once the plastic film material 72 has been processed by rotation of the blade and the material is chopped into small segments, the trap door 332 of the apparatus 302 is opened (such as by lifting of the trap door shown in the Figures by a piston mechanism 350 located on an outer surface of the outfeed chute 352). Thus, the processed material passes from the chamber 304 through the trap door 332 and into the outfeed chute 352 so it may be transferred to a storage silo for eventual transfer to an extruder line. In the embodiment shown in the Figures, the two agglomeration chambers 304 are used in tandem in a batch process operation and the material from each chamber 304 is transferred to a single storage silo to then be transferred to an extruder. Thus, the agglomeration process 300 of the apparatus 302 changes the physical state of the plastic film material, which goes into the process 300 as a sticky compact film material and exits the process 300 as a flowable course paste of small particles of plastic film that is suitable for collecting in a storage container such as a large silo, and may be readily removed from the storage container to then be transferred to an extruder line.

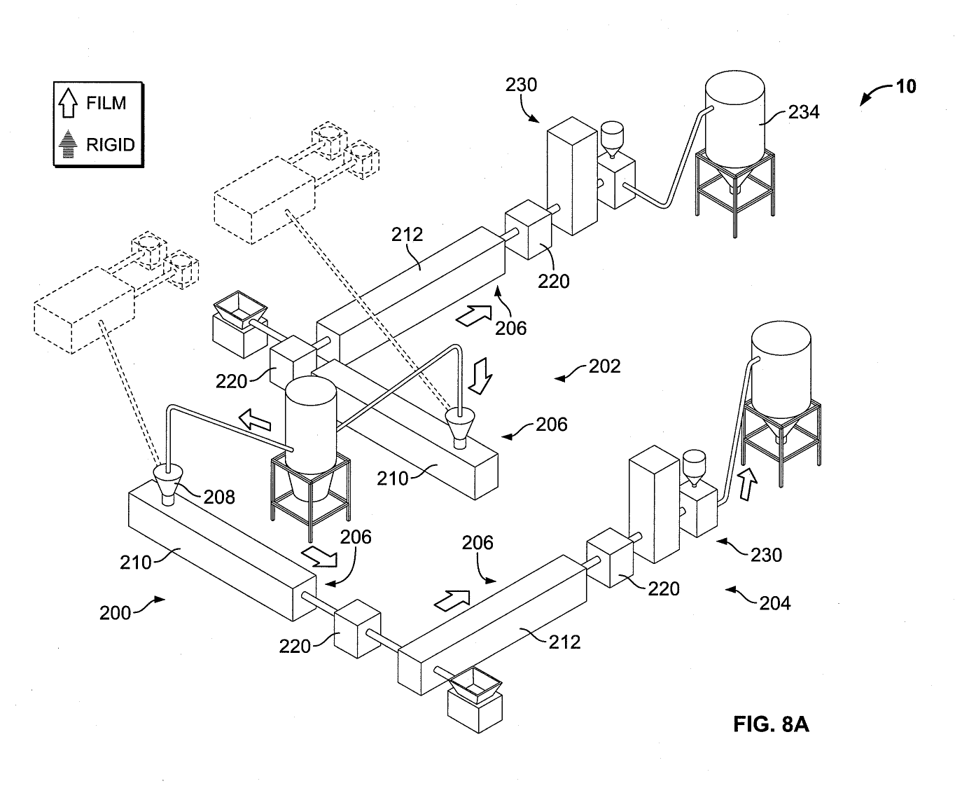

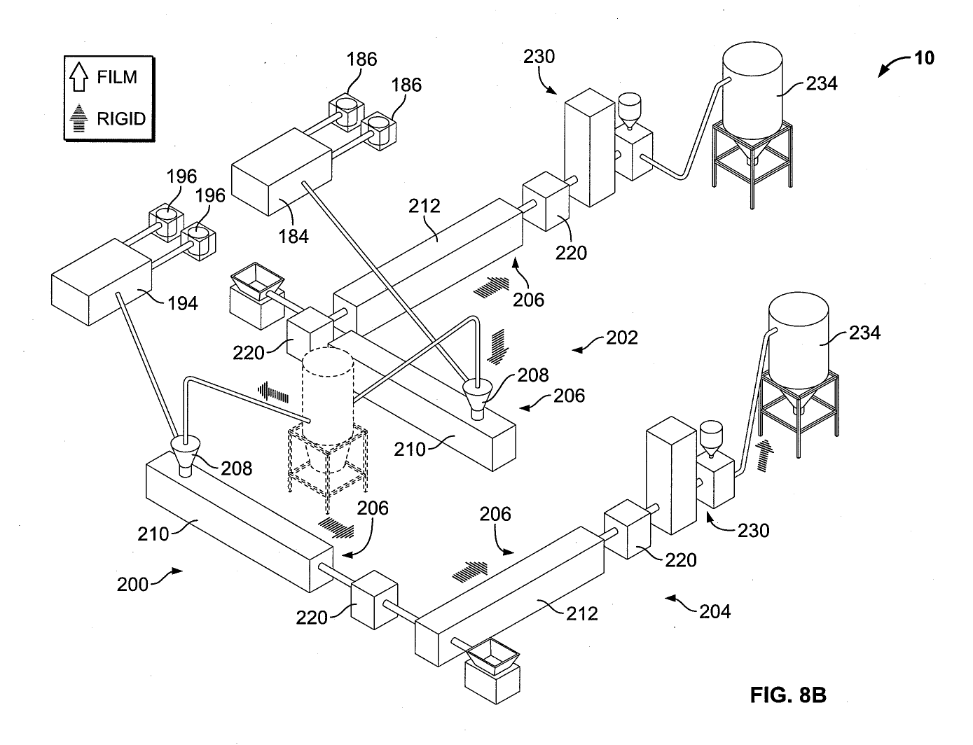

The extrusion step of the recycling processes of the apparatus 10 utilizes an extruder assembly 200 that preferably has two extrusion lines, a first extrusion line 202 and a second extrusion line 204, as shown in FIGS. 8A and 8B. Two extruder lines 202, 204 are preferred to run both simultaneously. When the rigid line 66 is operational, one extruder line 202 processes the material that separated to the top of the water tank 90 and was dried in the air blower passageway 170, while the other extruder line 204 processes the material that separated to the bottom of the water tank 90 and was dried in the centrifuge dryer apparatus 190 (and color separated in the color separation apparatus 194). Conversely, when the film line 70 is operational, both extruder lines 202, 204 are capable of running the dried plastic material simultaneously, increasing the output efficiency of the system.

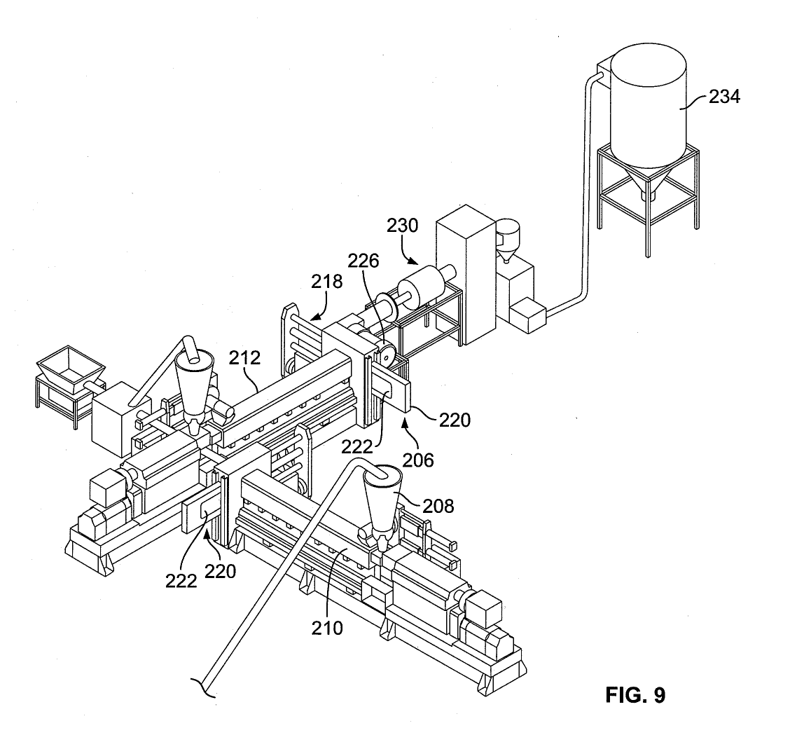

In the preferred form of the invention, each extruder line 202, 204 included multiple, preferably two, extruders 206 that are unified in line together as a continuous extrusion process. Each of the extrusion lines 202, 204 are substantially identical in components, each including an in-feed hopper 208 for receiving the cleaned plastic material and inserted into a first in-line extruder 210. The plastic material is heated and extruded into the first inline extruder 210, preferably as a twin-screw extruder, with conventional technique and extruder equipment. The material is passed from the first extruder 210 to a second in-line extruder 212, which is preferably positioned transverse to the first extruder 210, such that the two extruders are being generally transverse to one another as shown in the Figures. Significantly, the extrusion process through each extruder line 202, 204 includes at least one, and preferably two, screen filtration steps 216. Each screen filtration step 216 is a process in which the material form an extruder 210, 212 passes through a screen filtration device 218, which, as shown in FIG. 9, is preferably a conventional screen changer apparatus 220 that has at least two screens 222 so the extrusion process need not be interrupted when the screens 222 are changed. This arrangement of a screen changer apparatus 220 is configured to slide a filter screen 222 into the path of the extruded material passing in the tube extending from the extruder 210, 212. In the preferred form of the assembly 10, the screen filtration apparatus 218 is a dual screen changer with two having two screen changers 220 in line with the material from the extruder.

As shown in the Figures, each extrusion line 202, 204 preferably has two dual-screen changer apparatus, one located after each of the two in-line extruders 210, 212. In the preferred embodiment, each extrusion line 202, 204 also includes components for monitoring and adjusting the pressure in the extruder, such as utilizing a pressure gauge and joining a hot-melt pump 226 in communication with the extruder. This assembly for pressure regulation assist with the consistency and flow control of the material being extruded. This arrangement of multiple screen filtration 216 with each filtration step associated with an inline extruder 210, 212 is configured to filter contaminants from the plastic material being extruded and to enhance mixing of the extrusion material. This is a significant aspect of the process and apparatus of the invention, providing increased purity and uniformity of the recycled plastic end product. This end product is harvested by the final operation of pelletizing 228 the material in a pelletizer apparatus 230 associated with each extrusion line 202, 204. The pelletizer 230 utilizes conventional techniques for such devices, using water to cool the pellets and subjecting the pellets to a drying operation in a dryer assembly, and the resulting dried pellets are then transported to a finished product storage container 234.

The resulting harvested recycled pellets derived from the process steps disclosed herein have a remarkably high purity as compared with conventional recycling processes, primarily due to the unique washing process and multiple in-line extruders 210, 212 with screen filtration 216. In the case of the film line 70 in operation, the water wash process 100, which preferably includes use of a hot water washer 102 and a high speed mixer apparatus 112, is a process that results in high purity of the plastic material for extrusion because an increased amount of separation of contaminant debris is achieved in the water bath tank 90. This results in overall surprising levels of purity of the final extruded product. Further, with regard to both recycling lines 66, 70, the unique arrangements of multiple in-line extruders with intermediate filtration processes 216 provides a high purity of the final extruded pellet product.

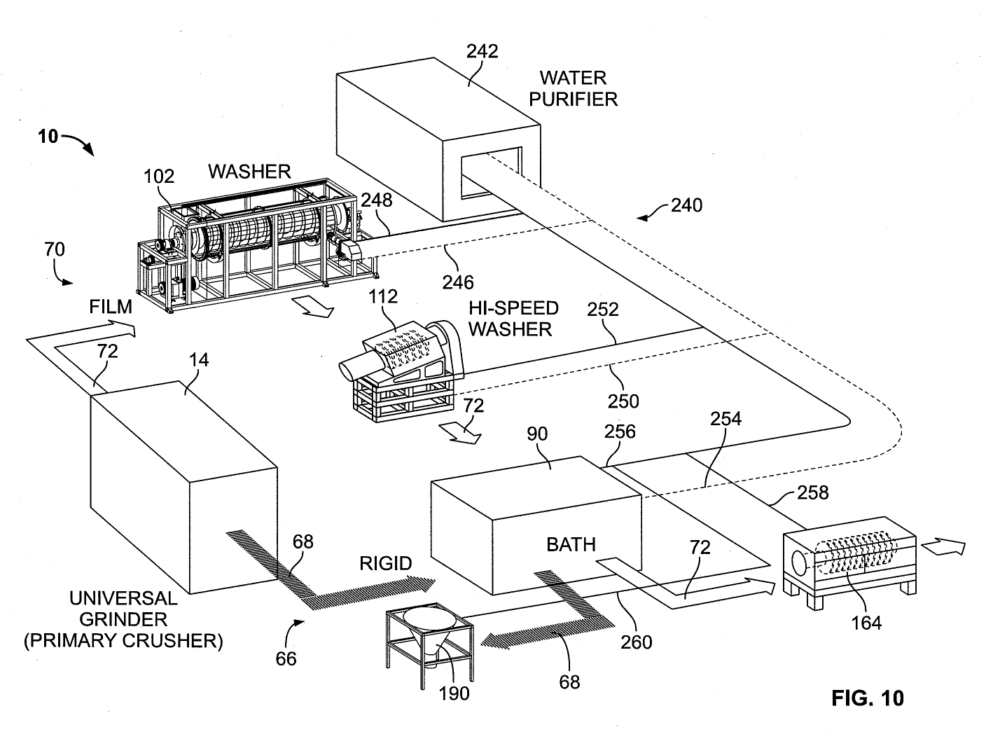

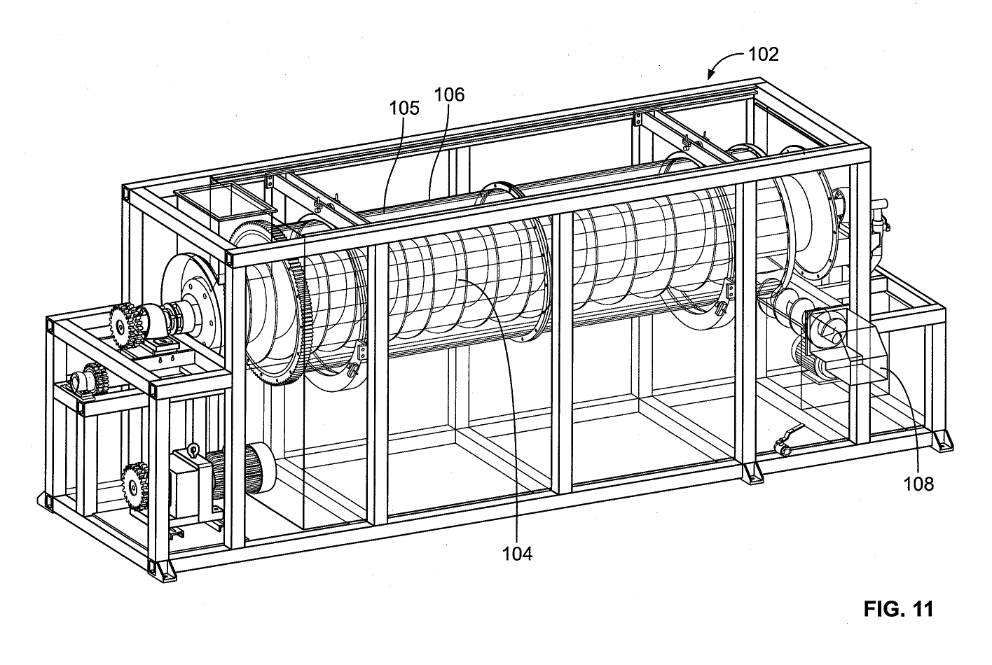

One advantage of the method and apparatus of the present invention is the efficiency of providing numerous components of a recycling process with a generally closed system for water use and purification. This aspect of the apparatus and process provides conservation of resources to operate a recycling process, increased efficiency and lessens waste produced as a by-product of the process. In a preferred form of the invention, several of the components of the system are interconnected to a single water purification assembly 240. As shown in FIG. 10, the water purification assembly includes a main water purification unit 242 that is configured to receive water from channels of the assembly 240, processes the received water through a water filtration process, and then expels purified water from the unit 242 through passageways leading to the components of the recycling process.

In the embodiment shown in FIG. 10, the main components utilizing water in the recycling process of the present invention are shown with connections to the water purification unit 242. Specifically, water from the purification unit 242 is delivered to the hot washer assembly 102 through a water supply conduit 246. This water is used in the hot washer 102 according to the description herein, which is preferably a substantially closed system of hot water introduced to the plastic material in the washer 102, which is then selectively drained when determined to be necessary, in which case it is expelled through a water drain conduit 248 that passes from the hot washer 102 to the water purification unit 242. Similarly, water is delivered to the high speed mixer assembly 112 through a supply conduit 250, which is used to supply the water that is delivered through the water spray assembly 134 (FIG. 12). Water that is then drained from the high speed mixer 112 at the drain assembly 136 (FIG. 12) is removed from the mixer and returned to the purification unit 242 by a drain conduit 252. Further, the small amount of water that is utilized in the agglomeration process 300, such as a filled agglomeration chamber 304, also is supplied from the filtered water supply of the apparatus 10. As similar loop of water supply and purification is present between the water purification unit 242 and the water bath tank 90, in which water is supplied to the tank 90 by the supply conduit 254 and the water that is expelled from the tank 90 when necessary for purification is delivered back to the purification unit 242 by the drain conduit 256. This essentially closed system of water supply, water use, draining and purification of the present invention provides an on-site and interconnected system that is substantially self-sustaining without the need to introduce large volumes of fresh water supplied into the system and without the need to burden municipal water treatment facilities. Further, this substantially closed water management system of the water purification assembly 240 includes capacity to purify the water that is drained from initial drying processes in the recycling process, such as the water that is removed from the spin dryer 164 is delivered to the water purification unit 242 through the drain passageway 258, and the water from the centrifuge drying apparatus 190 that is delivered to the purification unit 242 through the drain passageway 260.

What is claimed is:

1. An assembly for recycling plastic film, comprising:
a first shredder assembly having a shredder blade configured to cut the film into segments and a grinding assembly for cutting the film into smaller particles;
a multi-stage wash assembly comprising a hot wash apparatus and a water bath, said hot wash apparatus being configured to receive film from the grinding assembly and subjecting the film to a hot water wash and agitate the film material within the hot wash apparatus;
the water bath being configured to receive the material after exiting the hot wash assembly and to water soak the material and move the film material to an output;
a dryer apparatus configured to receive the film material after passing through the water bath and to substantially dry the film through a drier passageway with forced air;
an agglomeration assembly configured to receive washed film material after passing through the dryer apparatus and to substantially chop the film into small pieces of plastic that may be transported as a flowable material.

2. The assembly of claim 1 wherein the agglomeration assembly comprises:
a chamber configured to receive an amount of plastic film material and an agitator blade rotatably positioned along a surface of said chamber; and,
at least one cutter blade is positioned within the chamber, said cutter blade having a cutter edge that is generally opposes the rotational movement of the agitator blade.

3. The assembly of claim 2 wherein a plurality of cutter blades are positioned adjacent the outer circumference of the rotational movement of the agitator blade.

4. The assembly of 3 wherein the agitator blade is positioned at the bottom of a circular portion of said chamber adjacent a bottom wall of the chamber and rotational about a central axis, said agitator blade having at least one outer edge and wherein said plurality of cutter blades includes spaced stationary cutters positioned adjacent and radially outward the agitator blade outer edge when the agitator blade is rotated.

5. The assembly of claim 2 further comprising:
a portion of the inner wall of said chamber which is movable from a first position to form a part of the chamber to a second position to provide an opening to the chamber for removal of material within the chamber.

6. The assembly of claim 5 wherein:
said movable portion of the inner wall includes a portion of a sidewall of the chamber and a portion of the bottom wall of the chamber.

7. The assembly of claim 5 wherein:
the movable portion of the inner wall of the chamber is selectively controlled by a piston device that may be actuated to lift at least a portion of the inner wall.

8. An agglomeration assembly for use in a process of recycling plastic film material after washing the plastic film into a substantially pure amount of plastic film and at least partially drying the material, the agglomeration assembly including a chamber having a rotatable agitation blade and stationary cutting blades in position to cut the plastic film as it is moved by the agitation blade assembly.

9. The assembly of claim 8 wherein a plurality of said cutter blades are positioned adjacent the outer circumference of a rotational movement of the agitator blade.

10. The assembly of claim 8 wherein the agitator blade is positioned at the bottom of a circular portion of said chamber adjacent a bottom wall of the chamber and rotational about a central axis, said agitator blade having at least one outer edge and wherein a plurality of said cutter blades are configured to provide stationary cutting edges positioned adjacent and radially outward the agitation blade when rotated.

11. The assembly of claim 8 wherein:
a portion of an inner wall of said chamber is movable from a first position forming a part of the chamber to a second position exposing an opening to the chamber configured for removal of material within the chamber.

12. The assembly of claim 11 wherein:
said movable portion of the inner wall includes a portion of a sidewall of the chamber and a portion of a bottom wall of the chamber.

13. The assembly of claim 11 wherein:
the movable portion of the inner wall of the chamber is selectively controlled by a piston device that may be actuated to lift at least a portion of the inner wall.

14. A method of recycling plastic film material comprising:
providing plastic film material into an intake of a shredder assembly configured to shred the plastic material into an initial grind material;
conveying the initial grind material to a second film grinder assembly;
grinding the initial grind in said second film grinder assembly into a ground film material and subsequently soaking the ground plastic material in heated water and mixing the wet ground film material;
conveying the wet ground film material to a water bath and propelling the film material along a length of the water bath with rotating paddles toward a drying apparatus;
drying the plastic film material into a substantially dry ground plastic material;
conveying the dry ground plastic material to an agglomeration assembly for further cutting the film into a flowable material that may be transported along a screw-type conveyor and extruding the dry plastic material into plastic pellets.

15. The method of claim 14 wherein the step of further cutting the film in said agglomeration assembly includes the steps of:
moving the material in a general rotational path within the agglomerator by rotating an agitation blade, wherein said movement of the material is generally opposed by at least one cutter edge, and this step is continued until at least a substantial portion of the material is cut into a coarsely ground agglomeration suitable for transport along a screw conveyor.

16. The process of claim 15 further comprising the step of:
adding a relatively small amount of water to the agglomerator and subsequently mixing the contents of the chamber to assist with formation of flowable material.

17. The method of claim 15 wherein the amount of added water is approximately 500 milliliters in 150 pounds of material in the agglomerator.
